(19) United States
(12) Patent Application Publication
(10) Pub. No.: US 2026/0129095 A1
(43) Pub. Date: May 7, 2026

(54) COMMAND AND CONTROL DELIVERY MECHANISM

(71) Applicant: GM GLOBAL TECHNOLOGY OPERATIONS LLC, Detroit, MI (US)

(72) Inventors: Azin Neishaboori, Plymouth, MI (US); Venkata Naga Siva Vikas Vemuri, Farmington Hills, MI (US); Lakshmi V. Thanayankizil, Rochester Hills, MI (US); John Sergakis, Bloomfield Hills, MI (US); Mustafa H. Chmeiseh, Shelby Township, MI (US); Scott T. Droste, West Bloomfield, MI (US)

(73) Assignee: GM GLOBAL TECHNOLOGY OPERATIONS LLC, Detroit, MI (US)

(21) Appl. No.: 18/937,549

(22) Filed: Nov. 5, 2024

(51) Int. Cl. H04L 67/12; H04W 52/02

(52) U.S. Cl. CPC H04L 67/12; H04W 52/0229

(57) ABSTRACT

A system includes a first device, an internet-of-things ecosystem, and a vehicle The first device is operational to transmit a message to the internet-of-things ecosystem. The internet-of-things ecosystem is operational to transmit wirelessly the message per a given internet-of-things protocol to the vehicle. An internet-of-things-protocol capable circuit in the vehicle is operational to receive the message, wake up one or more modules in response to reception of the message, and transfer the message to the modules The modules are operational to process the message. The one or more modules are non-internet-of-things-protocol capable. The vehicle is operational to transmit an acknowledgement signal external to the vehicle in response to a completion of the processing of the message.

### INTRODUCTION

The present disclosure relates to a system and a method for a command and control delivery mechanism.

Current command and control mechanisms for automobiles depend on cellular short message service (SMS) messages sent over integrated management systems (ISM). Such messages consume considerable power due to registration overhead and may incur undesirable latency.

Accordingly, those skilled in the art continue with research and development efforts in the field of command and control delivery mechanisms.

### SUMMARY

A system is provided herein. The system includes a first device, an internet-of-things ecosystem, and a vehicle. The first device is operational to transmit a message via a first protocol. The internet-of-things ecosystem has an internet-of-things controller and one or more internet-of-things-protocol capable nodes. The internet-of-things controller is operational to receive the message from the first device per the first protocol. One of (i) the internet-of-things controller and (ii) the one or more internet-of-things-protocol capable nodes is operational to transmit wirelessly the message per a given internet-of-things protocol. The given internet-of-things protocol is different than the first protocol. The vehicle has an internet-of-things-protocol capable circuit and one or more modules. The internet-of-things-protocol capable circuit is operational to: receive the message per the given internet-of-things protocol from the internet-of-things ecosystem; wake up the one or more modules in response to reception of the message; and transfer the message to the one or more modules. The one or more modules are operational to process the message. The one or more modules are non-internet-of-thing-protocol capable. The vehicle is operational to transmit an acknowledgement signal external to the vehicle in response to a completion of the processing of the message.

In one or more embodiments of the system, the internet-of-thing-protocol capable circuit is further operational to: filter the message among a plurality of allowable messages in the given internet-of-things protocol; accept the message upon passing the filter; and reject the message upon failing the filter.

In one or more embodiments of the system, the internet-of-things-protocol capable circuit includes a vehicle transceiver operational to receive the message per the given internet-of-things protocol from the internet-of-things ecosystem. The vehicle transceiver is a low-power transceiver while in a standby mode. The internet-of-things-protocol capable circuit is operational to wake up the one or more modules in further response to acceptance of the message.

In one or more embodiments of the system, the internet-of-things ecosystem is further operational to register the vehicle with the internet-of-things controller prior to transmission of the message to the vehicle. The vehicle is an internet-of-things device while registered.

In one or more embodiments of the system, the vehicle further includes a vehicle transceiver. The vehicle transceiver is operational to transmit wirelessly the acknowledgement signal directly to the first device using a second protocol. The second protocol is different than the given internet-of-things protocol.

In one or more embodiments of the system, the vehicle further includes a vehicle transceiver. The vehicle transceiver is operational to transmit wirelessly the acknowledgement signal to the internet-of-things controller per the given internet-of-things protocol.

In one or more embodiments of the system, the internet-of-things-protocol capable circuit hosts an internet-of-things hub. The internet-of-things hub is operational to communicate via a plurality of internet-of-things supported technologies.

In one or more embodiments of the system, the internet-of-things ecosystem is further operational to establish a multi-hop path through the one or more internet-of-things nodes between the internet-of-things controller and the vehicle.

In one or more embodiments, the system includes a smart device operational to transmit the message to the first device. The first device is a server computer operational to receive the message from the smart device. The server computer is operational to transfer wirelessly the message to the internet-of-things controller via the first protocol.

In one or more embodiments, the system includes a smart device operational to transmit the message directly to the internet-of-things controller via the given internet-of-things protocol. The first device is a server computer. The message from the smart device to the internet-of-things controller bypasses the server computer.

In one or more embodiments of the system, the internet-of-things ecosystem is further operational to cascade the message received from the first device. The internet-of-things ecosystem includes a designated trusted internet-of-things node of the one or more internet-of-things nodes. The vehicle includes a vehicle transceiver. The vehicle transceiver is operational to transmit wirelessly a check-for-command message periodically per a second protocol to the designated trusted internet-of-things node for the message. The second protocol is different than the given internet-of-things protocol. The internet-of-things ecosystem is further operational to transmit wirelessly the message to the vehicle transceiver per the second protocol in response to reception of the check-for-command message.

In one or more embodiments of the system, the vehicle transceiver is further operational to transmit wirelessly the acknowledgement signal to the designated trusted internet-of-things node per the second protocol.

In one or more embodiments of the system, the vehicle further includes a battery. The battery has a state-of-charge. A period of the transmission of the check-for-command message from the vehicle transceiver is varied in response to one or more of (i) the state-of-charge of the battery and (ii) a configuration latency.

In one or more embodiments of the system, the internet-of-things-protocol capable circuit is further operational to register the one or more modules as a pre-condition to transfer the message from the internet-of-things-protocol capable circuit to the one or more modules.

In one or more embodiments of the system, a designated trusted internet-of-things node of the one or more internet-of-things nodes in the internet-of-things ecosystem is further operational to authenticate the one or more additional circuits in the vehicle as a pre-condition to transmit the message from the designated trusted internet-of-things node to the vehicle.

In one or more embodiments of the system, the designated trusted internet-of-things node is further operational to filter the message based on the authentication of the one or more modules. The message is transmitted to the vehicle in response to passing the filter. The message is withheld from the vehicle in response to failing the filter.

In one or more embodiments of the system, the given internet-of-things protocol is a Matter protocol defined by Matter.

A method for a command and control delivery is provided herein. The method includes transmitting a message via a first protocol from a first device, receiving the message per the first protocol at an internet-of-things controller in an internet-of-things ecosystem from the first device, transmitting wirelessly the message per a given internet-of-things protocol from one of (i) the internet-of-things controller and (ii) one or more internet-of-things nodes in the internet-of-things ecosystem, receiving the message per the given internet-of-things protocol at an internet-of-things-protocol capable circuit in a vehicle from the internet-of-things ecosystem, and waking up one or more modules in the vehicle with the internet-of-things-protocol capable circuit in response to the receiving of the message. The one or more modules are non-internet-of-things-protocol capable. The method includes transferring the message from the internet-of-things-protocol capable circuit to the one or more modules additional, processing the message with the one or more modules; and transmitting an acknowledgement signal from the vehicle in response to a completion of the processing of the message.

In one or more embodiments, the method includes cascading the message received from the first device in the internet-of-things ecosystem. The internet-of-things ecosystem includes a designated trusted internet-of-things node of the one or more internet-of-things nodes. The vehicle includes a vehicle transceiver. The method further includes transmitting wirelessly a check-for-command message periodically per a second protocol from the vehicle transceiver to the designated trusted internet-of-things node for the message, wherein the second protocol is different than the given internet-of-things protocol, and transmitting wirelessly the message from the internet-of-things ecosystem to the vehicle transceiver per the second protocol in response to reception of the check-for-command message at the internet-of-things ecosystem.

A vehicle is provided herein. The vehicle includes a vehicle transceiver, one or more modules, an internet-of-things-protocol capable circuit, and a wireless transceiver. The vehicle transceiver is operational to receive a message per a given internet-of-things protocol from an internet-of-things ecosystem. The vehicle is registered with an internet-of-things ecosystem as an internet-of-things device. The one or more modules are operational to process the message. The one or more modules are non-internet-of-things-protocol capable circuits. The internet-of-things-protocol capable circuit operational to: wake up the one or more modules in response to reception of the message; transfer the message to the one or more modules; and host an internet-of-things hub. The internet-of-things hub is operational to communicate via a plurality of internet-of-things supported technologies. The vehicle transceiver is further operational to transmit an acknowledgement signal external to the vehicle in response to a completion of the processing of the message. The wireless transceiver is operational to link the vehicle to the Internet, send data to the Internet, and receive data from the Internet.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic plan diagram illustrating a system involving a vehicle in accordance with one or more exemplary embodiments.

FIG. 2 is a schematic functional flow diagram of operations of the system in accordance with one or more exemplary embodiments.

FIG. 3 is a schematic functional flow diagram of operations of another system in accordance with one or more exemplary embodiments.

FIG. 4 is a schematic sequence diagram of a first sequence in accordance with one or more exemplary embodiments.

FIG. 5 is a schematic functional flow diagram of operations of still another system in accordance with one or more exemplary embodiments.

FIG. 6 is a schematic sequence diagram of a second sequence in accordance with one or more exemplary embodiments.

### DETAILED DESCRIPTION

Embodiments of the disclosure provide a system and/or method for command and control mechanisms. The system/method is generally characterized directed to an alternative to the use of the small message service (SMS) protocol in communications between an internet-of-things (IoT) ecosystem and a vehicle that may be in ignition-off mode, i.e., in a low-power-mode, and able to use a small amount of power. The use of SMS to perform command and control on vehicles consumes high energy, and may incur high latency, the former resulting in fast battery drain, while the latter may result in poor customer experience. The vehicle may be registered with the IoT ecosystem as a IoT device. An internet-of-things (IoT) capable module (or circuit) with a vehicle may be continuously powered on, either continuously or intermittently via the use of a low-power, standby or sleep mode, even though the rest of the vehicle systems are powered down. The continuously powered on enables the vehicle's IoT capable module to remain responsive (e.g., listen for new incoming messages, send responses to the incoming messages, and/or send periodical messages to maintain connection and membership of the IoT ecosystem operating over an IoT ecosystem protocol, such as Matter).

When a message is received that contains a command for the vehicle, i.e., an action to be taken by the vehicle, such as collecting diagnostics data, turn the vehicle on, adjust vehicle settings like seat or mirror positions, the IoT-protocol capable module may wake up one or more regular (e.g., non-IoT=protocol capable) modules (or circuits) to execute the command. Once the execution of the command is complete, the vehicle may send an acknowledgement (ACK) signal back to a user that initiated the command via the network of the IoT ecosystem. Alternatively, the ACK may be sent using a non-IoT-protocol capable based communication method, e.g., over a cellular connection to a backend entity that manages and processes vehicle command and control services. In various embodiments, when a smart device of the user such as smart phone or smart watch is part of the same IoT ecosystem as the vehicle is, the command issued by the user is communicated to the IoT ecosystem via the smart device. In some embodiments, the vehicle, upon joining the IoT ecosystem, registers itself, over an application service, with the IoT controller to request for the command and control messages arriving from the remote (backend) command and control server (backend entity, that may run on a cloud platform) responsible for dispatching command and control services sent to vehicles) to be sent to the IoT controller. The IoT controller, as part of the requested service in the application, establishes a relationship with the backend command and control ecosystem. According to such embodiments, when the device used by the user to issue a command to the vehicle is not in the same IoT network as the vehicle, the command is first sent, via the internet, to the remote (backend) cloud server. The cloud server sends the message containing the command to the vehicle through the IoT controller, that is connected to the Internet. The IoT controller relay the messages arriving for the vehicle to the vehicle over the IoT network.

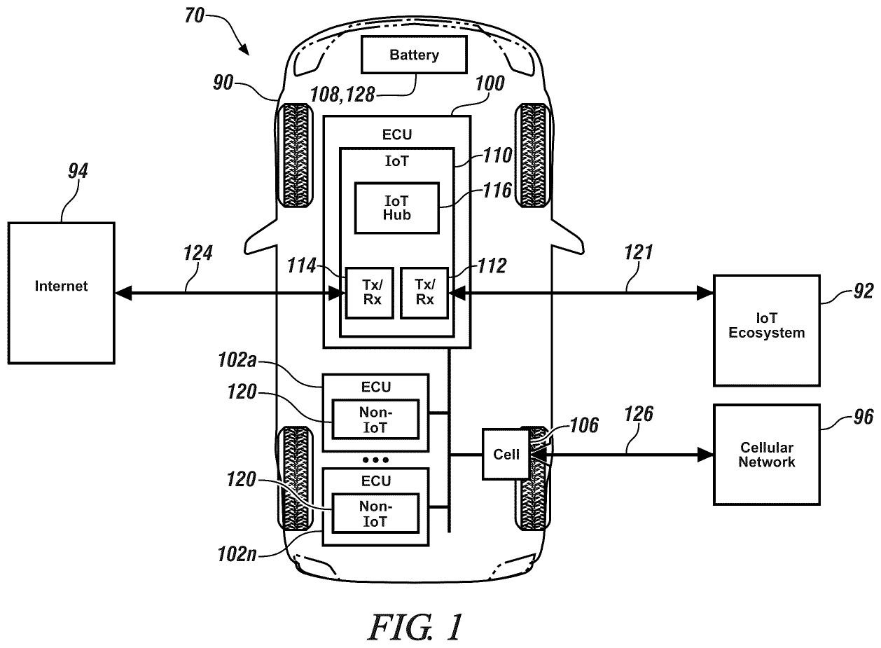

Referring to FIG. 1, a schematic plan diagram illustrating a system 70 involving a vehicle 90 is shown in accordance with one or more exemplary embodiments. The system 70 may include the vehicle 90, an IoT ecosystem 92, the (optional) Internet 94, and an (optional) cellular network 96. The vehicle 90 generally includes a first electronic control unit (ECU), multiple second ECUs 102a-102n, an optional cellular transceiver 106, and a battery 108. The IoT (or Matter) capable ECU 100 may include an IoT (or Matter) capable circuit 110, a wireless vehicle transceiver 112, and a wireless transceiver 114. The IoT capable circuit 110 may host an IoT hub 116 that may be operational to translate and map between messages from various IoT protocols, or a regular IoT device. Each second ECU 102a-102n generally includes one or more non-IOT protocol (or non-Matter) capable circuits 120 (one shown in each second ECU 102a-102n).

The vehicle 90 implements a gas-powered vehicle, an electric vehicle, a hybrid vehicle, or a plug-in hybrid vehicle. In various embodiments, the vehicle 90 may include, but is not limited to, a passenger vehicle, a truck, an autonomous vehicle, a motorcycle, a boat, and/or an aircraft. Other types of vehicles 90 may be implemented to meet the design criteria of a particular application.

The IoT ecosystem 92 may implement a home IoT ecosystem. In various embodiments, the IoT ecosystem 92 may be compliant with Matter. A protocol in Matter may be referred to herein as a Matter protocol. In other embodiments, the IoT ecosystem 92 may be compliant with a given IoT protocol among other IoT protocols. In such cases, a connectivity protocol may be referred to herein as a given IoT protocol. The IoT ecosystem 92 is operational to transmit information 121 to and from the vehicle transceiver 112.

The Internet 94 may exchange data 124 with the wireless transceiver 114. The data 124 may be transferred via wires and/or wirelessly along the Internet 94. In various embodiments, the IoT ecosystem 92 may communicate via the Internet 94.

The cellular network 96 implements a telephone/data network. The cellular network 96 generally provides wireless data and/or voice communications with the network nodes, such as the cellular transceiver 106.

The first electronic control unit (ECU) 100 implements multiple digital computation circuits. The digital computation circuits may transfer data with one another across a communications bus. The digital computation circuits may be implemented in hardware, software executing on hardware, or a combination of both. The first ECU 100 may include low-power circuitry and regular circuitry. The low-power circuitry is capable of entering a low-power mode to listen for wake up signals while the vehicle 90 is in an off state. The regular circuitry may be non-operational while the vehicle 90 is in an off state and operational while the vehicle 90 is in an on state and/or one or more intermediate states. The low-power circuitry is operational to wake up the regular circuitry within the first ECU 100 in response to receiving the wake up signal. In some embodiments, the wake up signal is an initial message received while the low-power circuitry is in the low-power mode. In other embodiments, the wake up signal is a separate signal from a subsequent message that contains vehicle commands.

The first ECU 100 may send messages to and receive messages from 121 from the IoT ecosystem 92 via the vehicle transceiver 112. Bidirectional data 124 may also be exchanged with the Internet 94 using the wireless transceiver 114. Additional bidirectional data 126 may be exchanged with other devices (not shown) on a cellular network through the cellular transceiver 106.

Each second ECUs 102a-102n implements multiple digital computation circuits. The digital computation circuits may transfer data with one another across a communications bus. The digital computation circuits may be implemented in hardware, software executing on hardware, or a combination of both. Each second ECU 102a-102n may include regular circuitry. The regular circuitry may include the non-IoT-protocol capable circuits 120. The non-IoT-protocol capable circuits 120 are in communication with the IoT-protocol capable circuit 110. The non-IoT-protocol capable circuits 120 may be non-operational while the vehicle 90 is in an off state and operational while the vehicle 90 is in an on state and/or one or more intermediate states. Transitions of the non-IoT-protocol capable circuits 120 from non-operational to operational is controlled, in part, by the IoT-protocol capable circuit 110 receiving (i) a wake up signal followed by an initial message or (ii) just the initial message as an implied wake up signal.

The cellular transceiver 106 implements a cellular network node operational to communicate digital messages on a cellular network 96.

The battery 108 implements an automotive battery, battery module, or a battery pack. The battery 108 may have a state-of-charge 128 that depends on an amount of energy stored therein. The state-of-charge 128 generally effects a periodic rate at which the first ECU 100 sends a check-for-command message to the IoT ecosystem 92. A latency criteria may also effect the periodic rate at which the first ECU 100 sends the check-for-command message to the IoT ecosystem 92.

The IoT-protocol capable circuit 110 implements continuously responsive circuit operational to listen for a wake up signal/initial message, provide bidirectional communications with the IoT ecosystem 92, and provide bidirectional communications cellular communications 126. The wake up signal may be received by the IoT-protocol capable circuit 110 from the IoT ecosystem 92 via the vehicle transceiver 112, from the Internet 94 via the wireless transceiver 114 and/or over the cellular network via the cellular transceiver 106. The IoT-protocol capable circuit 110 is operational to communicate with the IoT ecosystem 92 via the vehicle transmitter 104 and the vehicle receiver 112 using the given IoT protocol. The IoT-protocol capable circuit 110 may also host the IoT hub 116.

The vehicle transceiver 112 implements a low-power wake up transceiver. The vehicle transceiver 112 is operational to receive communications from the IoT ecosystem 92 using an IoT protocol, such as the Matter protocol. The received communications may be provided in the first ECU 100, and in particular, to the IoT-protocol capable circuit 110.

The wireless transceiver 114 implements a radio-frequency transceiver. The wireless transceiver 114 is operational to exchange information between the vehicle 90 and the Internet 94. The information may be transferred using a wireless Internet protocol.

The IoT hub 116 acting as a Matter hug may be defined in Matter.

The non-IoT-protocol capable modules (or circuits) 120 implement a variety of circuitry normally found in the vehicle 90. By way of example, the non-IoT-protocol capable circuits 120 may include body control module circuitry, infotainment circuitry, and the like. Other non-IoT-protocol circuits may be implemented to meet the design criteria of a particular application. The non-IoT-protocol capable circuits 120 are not designed to communicate via the given IoT protocol.

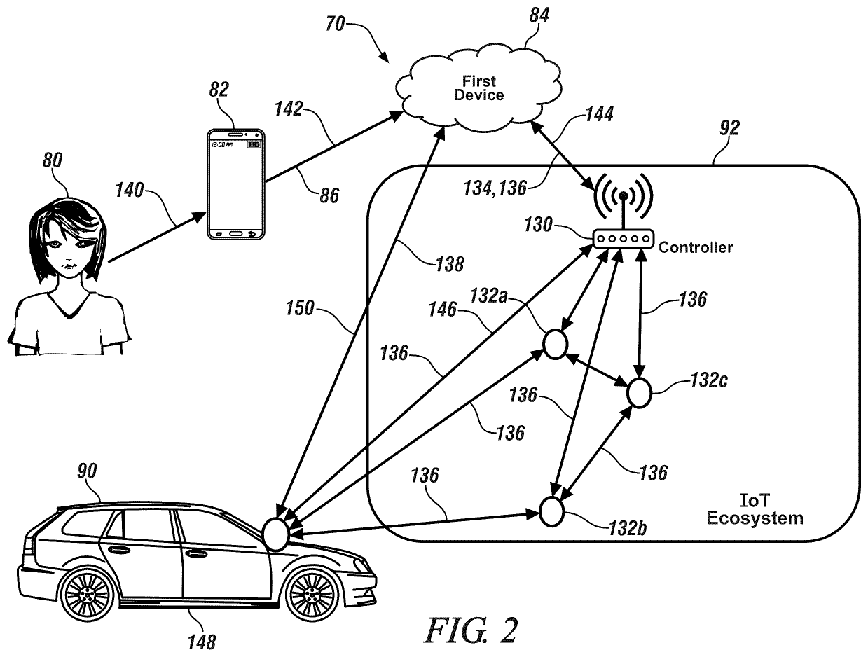

Referring to FIG. 2, a schematic functional flow diagram of a first example operation of the system 70 is shown in accordance with one or more exemplary embodiments. The system 70 may include a smart device 82 operated by a user 80, a first device 84, the IoT ecosystem 92 and the vehicle 90. The IoT ecosystem 92 generally includes an IoT controller 130 and multiple IoT-protocol capable nodes 132a-132c. The operations may include steps 140 to 150, as illustrated. The sequence of steps is shown as a representative example. Other step orders may be implemented to meet the criteria of a particular application.

The smart device 82 implements a hand-held device. In various embodiments, the smart device 82 may be a smart phone, a laptop computer, a notebook, a tablet or the like. The smart device 82 may exchange information with the first device 84 via a cellular network (e.g., the cellular network 96 in FIG. 1) and or the Internet 94 (FIG. 1). The smart device 82 may receive inputs from the user 80 and translate the inputs into command and control messages 86. For example, a command and control message 86 may be a start engine message. Another command and control message 86 may be a set a climate control message.

In various embodiments, the first device 84 implements a cloud server computer or multiple server computers that may be implemented on a cloud platform or on the premise of a business. The first device 84 may communicate with the smart device 82 and with the IoT controller 130. Communication with the IoT controller 130 may be according to a first protocol. The first protocol may be a wired and/or wireless protocol. For example, the first protocol may be a Wi-Fi protocol. In other embodiments, the first device 84 may be the smart device 82. Therefore, the smart device 82 may communicate directly with the IoT controller 130 and bypass a cloud server computer, if present.

The IoT controller 130 implements a Wi-Fi capable access point, communicating with one or more IoT devices within the IoT ecosystem using Wi-Fi technology. The application/service layer the IoT controller 130 uses Matter or another IoT protocol. The IoT controller 130 may be directly or indirectly connected to an internet gateway. The IoT controller 130 and internet gateway may be collocated. The IoT controller 130 is operational to exchange data with the cloud server computer (first device 84) via a first protocol 134. Data may also be exchanged between the IoT controller 130 and the IoT-protocol capable nodes 132a-132c via the given IoT protocol 136. In various embodiments, the first protocol 134 is different than the given IoT protocol 136. In other embodiments, the first protocol 134 may implement the given IoT protocol 136.

Each IoT-protocol capable node 132a-132c implements an addressable entity that supports IoT protocol stack. The IoT-protocol capable nodes 132a-132c may communicate among each other and with the IoT controller 130 via the given IoT protocol and/or the Matter protocol.

In the step 140, the user 80 may trigger a message via a command and control application executing on the smart device 82. The smart device 82 may transmit the message 86 to the first device 84 in the step 142. The first device 84 may exchange data with the IoT controller 130 to determine if the vehicle 90 is registered with the IoT controller 130. The registration may be a pre-condition prior to transferring the message 86. If registered, the first device 84 transmits the message 86 in the step 144 to the IoT controller 130. If not registered, the first device 84 may provide a message to the user 80 to prompt the user 80 for taking actions for the vehicle 90 to be registered then or at a later time. If registration is not completed, the command message from the first device 84 does not reach the vehicle 90 with the help of the IoT controller 130 over Matter. Upon such determination, the message may be delivered to the vehicle 90 over an alternative route, such as SMS.

In the step 146, the IoT controller 130 sends the message to the vehicle 90 per the given IoT protocol. The IoT-protocol capable circuit 110 in the vehicle 90 may receive the message 86. If the non-IoT-protocol capable circuits 120 in the vehicle are powered down and the message 86 is a wake up signal, the IoT-protocol capable circuit 110 wakes up one or more non-IoT-protocol capable circuits 120 in the step 146 and transfers the message 86. If one or more non-IoT-protocol capable circuits 120 that the action requested in the message 86 is intended for are already awake, the action requested signal are transferred from the IoT-protocol capable circuit 110. Subsequently, the action(s) requested in the message 86 is executed by the module(s) whose actions is/are appropriate to complete the command included in message 86.

Once execution of the message completes, the vehicle 90 may send an acknowledgement message (ACK) 138 in the step 150 directly to first device 84 (via internet-connected Wi-Fi or cellular link) or respond back to the IoT controller 130. The IoT controller 130 may notify the first device 84 of the completion. The first device 84 notifies the smart device 82 and the smart device 82 notifies the user 80 that the message has been acted upon.

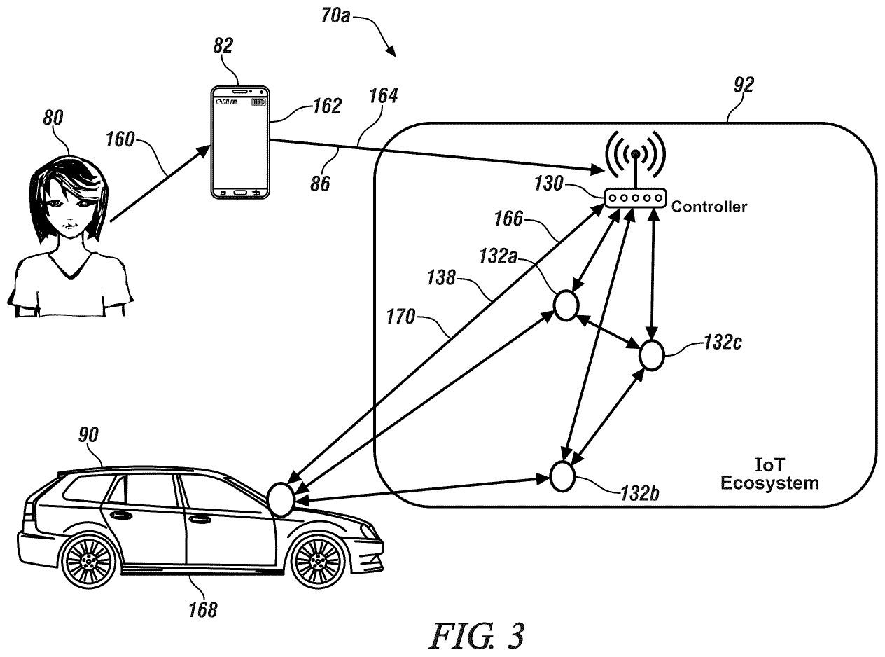

Referring to FIG. 3, a schematic functional flow diagram of a second example operation of a system 70a is shown in accordance with one or more exemplary embodiments. The system 70a may be a variation of the system 70 (FIGS. 1 and 2). The system 70a includes the smart device 82 operated by the user 80, the IoT ecosystem 92, and the vehicle 90. In this embodiment, the smart device 82 is part of the same IoT ecosystem as the vehicle 90. The system 70a may not utilize the first device 84 (FIG. 2). The operations may include steps 160 to 170, as illustrated. The sequence of steps is shown as a representative example. Other step orders may be implemented to meet the criteria of a particular application.

In the step 160, the user 80 may trigger a message 86 via a command and control application executing on the smart device 82. The smart device 82 may exchange data with the IoT controller 130 to determine if the vehicle 90 is registered with the IoT controller 130 in the step 162. If registered, the smart device 82 transmits the message 86 in the step 164 to the IoT controller 130. If not registered, the smart device 82 may utilize an alternative route to reach out to the vehicle, e.g., using cellular communication-based messages such as SMS.

In the step 166, the IoT controller 130 sends the message to the vehicle 90 per the given IoT protocol. The IoT-protocol capable circuit 110 in the vehicle 90 may receive the message 86. If the non-IoT-protocol capable circuits 120 in the vehicle are powered down and the message 86 is a wake up signal, the IoT-protocol capable circuit 110 wakes up one or more non-IoT-protocol capable circuits 120 in the step 168. If the message 86 contains a command to execute that one or more non-IoT-protocol capable circuits 120 may perform but are asleep, such modules ae woken up by the IoT-protocol capable module 110. Once the command contained within the message 86 is received by the non-IoT-protocol capable circuits 120, the action requested in the message 86 is executed. Registration of the non-IoT-protocol capable circuits 120 in the IoT-protocol capable circuit 110 may be a pre-condition to send the messages from the IoT-protocol capable circuit 110 to the non-IoT protocol capable circuits 120.

After execution of the command within the message completes, the vehicle 90 may send an acknowledgement message (ACK) 138 back to the IoT controller 130 in the step 170. The IoT controller 130 may notify the smart device 82 of the completion. The smart device 82 notifies the user 80 that the message has been acted upon.

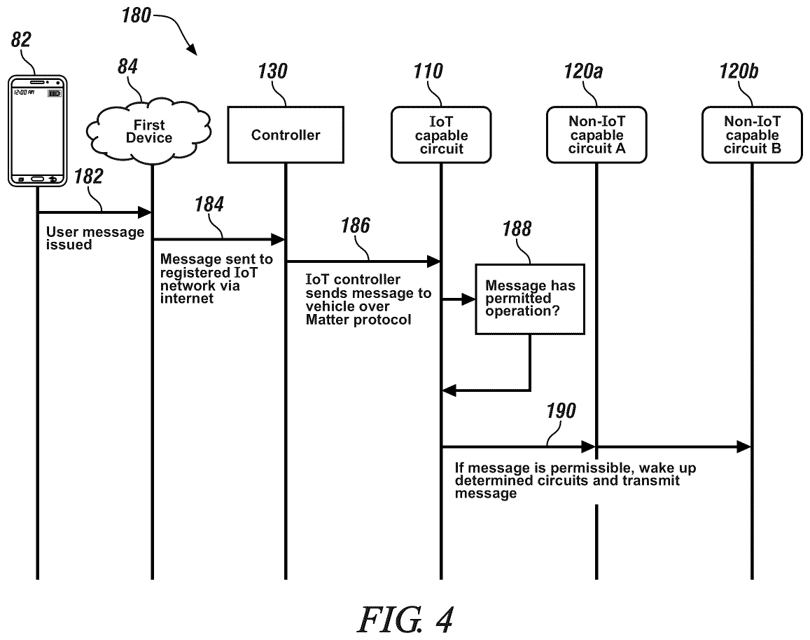

Referring to FIG. 4, a schematic sequence diagram of a first example sequence 180 is shown in accordance with one or more exemplary embodiments. The sequence 180 utilizes the smart device 82, the first device 84 (e.g., cloud server computer), the IoT controller 130, the IoT-protocol capable circuit 110, and two non-IoT-protocol capable circuits 120 (e.g., 120a-120b). The sequence 180 includes operations 182 to 190, as illustrated. Other operation orders may be implemented to meet the criteria of a particular application.

In the operation 182, the smart device 82 transmits the message to the first device 84. The first device 84 sends the message to the IoT controller 130 in the operation 184, wherein the IoT controller 130 has been registered (e.g., over the Internet 94, initiated by the smart device 82 or the IoT controller 130 itself) with the first device 84 as the entity which is to receive the command and control messages intended for vehicle 90 that is part of the IoT ecosystem 92. In the operation 186, the IoT controller 130 sends the message to the vehicle 90 over the given IoT protocol. In the operation 188, the IoT-protocol capable circuit 110 processes the IoT message; determines if the IoT message requests a permitted operation; determines the non-IoT-protocol capable circuits 120a-120b appropriate to be woken up and reached to so as to execute a command contained in the IoT message. If the message is permitted, the IoT-protocol capable circuit 110 wakes up the determined non-IoT-protocol capable circuits 120a-120b in the operation 190 in order to execute the command contained within the message.

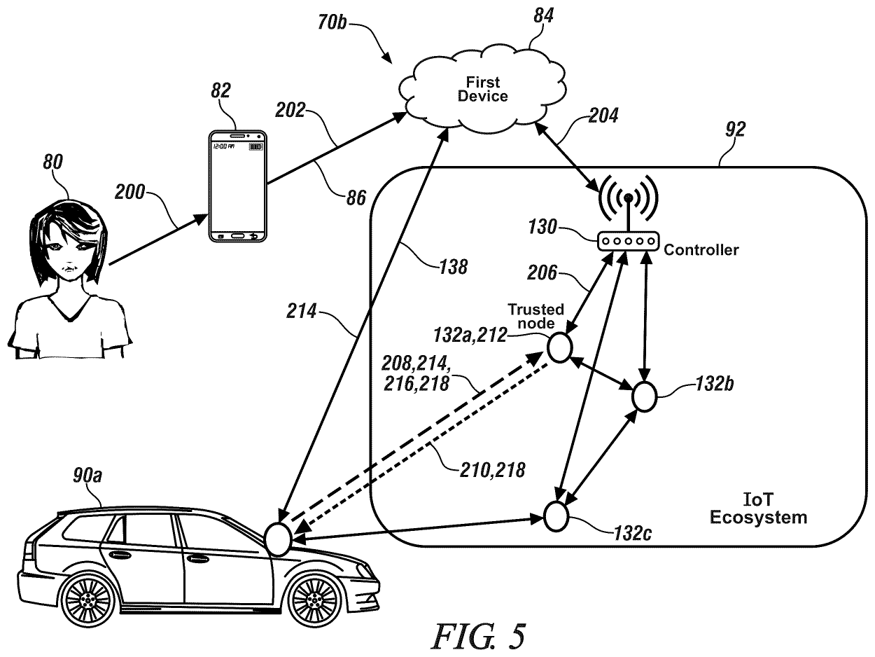

Referring to FIG. 5, a schematic functional flow diagram of a third example operation of a system 70b is shown in accordance with one or more exemplary embodiments. The system 70b may be a variation of the system 70 (FIGS. 1 and 2) and/or the system 70a (FIG. 3). The system 70b includes the smart device 82 operated by the user 80, the first device 84, the IoT ecosystem 92, and a vehicle 90a. The vehicle 90a may be a variation of the vehicle 90. The vehicle 90a may lack IoT-protocol capable circuitry. The operations may include steps 200 to 214, as illustrated. The sequence of steps is shown as a representative example. Other step orders may be implemented to meet the criteria of a particular application.

In the step 200, the user 80 may trigger a message via a command and control application executing on the smart device 82. In the step 202, the smart device 82 transfers the message 86 to the first device 84. The first device 84 may exchange data with the IoT controller 130 to determine if the vehicle 90a is registered with the IoT ecosystem 92. If registered, the first device 84 transmits the message 86 in the step 204 to the IoT controller 130 where the message 86 is buffered. If not registered, the first device 84 may check with other IoT ecosystems for registration of the vehicle 90a. In the step 206, the IoT controller 130 sends the message 86 to a designated trusted IoT-protocol capable node (e.g., 132a) that is part of ecosystem 92.

A non-IoT-protocol capable circuit, such as 120, in the vehicle 90 periodically transmits a check-for-command message 216 to the IoT ecosystem 92 in the step 208. The check-for-command message 216 may utilize a non-IoT-protocol compatible interface 218 and a low-power wireless technology such as Bluetooth or Bluetooth Low Energy (BLE), Zigbee, or other technologies. The designated trusted IoT-protocol-capable node 132a responds to the recently-received check-for-command message 216 by checking for the message 86 in a local buffer 212. The designated trusted IoT-protocol capable node 132a responds to the vehicle 90 using the non-IoT protocol 218. The response may indicate that a message 86 for the vehicle 90a is present in the buffer 212, or not.

In the step 210, a non-IoT-protocol capable circuit 120 receives the message 86, and wakes up one or more other non-IoT-protocol capable circuits 120 as appropriate to execute the command contained within the message 86. In the step 214, the vehicle 90a contacts (i) the designated trusted IoT-protocol capable node 132a over the non-IoT protocol capable interface 218 or (ii) the first device 84 over Wi-Fi, cellular connection, or other non-IoT-protocol compatible link to receive follow-up messages 86 or to acknowledge 138 execution completion of the previous message 86.

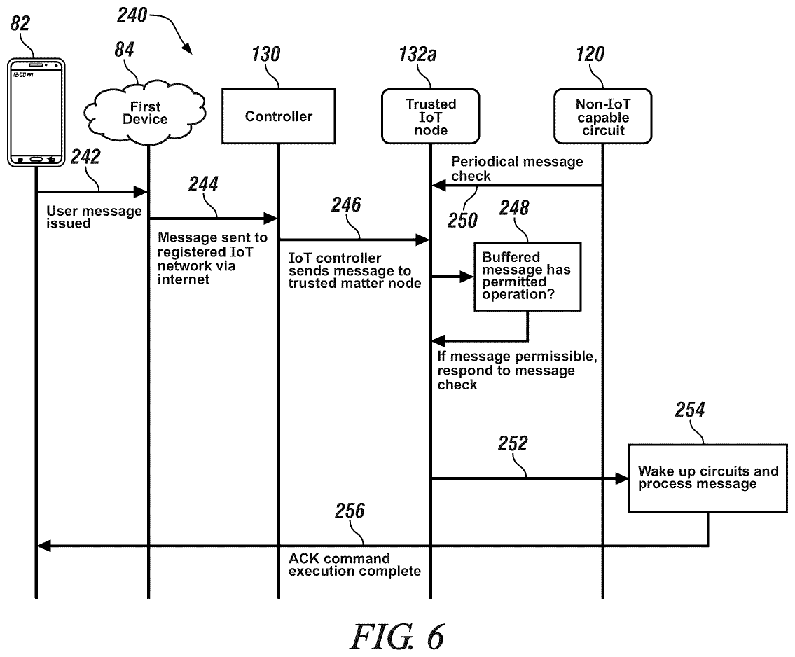

Referring to FIG. 6,, a schematic sequence diagram of a second example sequence 240 is shown in accordance with one or more exemplary embodiments. The sequence 240 utilizes the smart device 82, the first device 84, the IoT controller 130, the designated trusted IoT-protocol capable node 132a, and a non-IoT-protocol capable circuit 120. The sequence 240 includes operations 242 to 256, as illustrated. Other operation orders may be implemented to meet the criteria of a particular application.

In the operation 242, the smart device 82 transmits the message 86 to the first device 84. The first device 84 sends the message 86 to the IoT controller 130 in the operation 244, wherein the IoT controller 130 has registered with the first device 84 directly, or has been registered with the first device 84 by the smart device 82, as to identify the IoT controller 130 to receive the command and control messages destined for vehicle 90a while the vehicle 90a is in the IoT network that the controller 130 is part thereof. In the operation 246, the IoT controller 130 cascades (or sends) the message to the designated trusted IoT-protocol capable node 132a over the given IoT protocol. In the operation 248, the designated trusted IoT-protocol capable node 132a processes the message; determines if a request of the message is a permitted operation, and if permitted, buffers the message.

The vehicle 90a transmits a check-for-command message to the designated trusted IoT-protocol capable node 132a in the operation 250. If the message is permissible, the designated trusted IoT-protocol capable node 132a responds to the check-for-command message in the step 252 with the message as buffered. In the operation 254, one or more appropriate non-IoT-protocol capable circuits 120 are woken up, provided the message, process the message, and execute the command included within the message. Once the message processing and command execution is complete, the vehicle 90a sends the acknowledgement signal back to the smart device 82 via the designated trusted IoT-protocol capable node 132a, and the IoT controller 130, and the first device 84 in the operation 256.

Various embodiments of the systems and/or methods generally provide command and control (e.g., message) transmission using the IoT protocol to reach IoT-protocol capable modules that wake up non-IoT-protocol capable modules. An IoT-protocol capable circuit in the vehicle provides filtering and/or determination if the message is among allowed messages over the IoT protocol compatible links. The message may be accepted upon passing the filter and rejected upon failing the filter.

The IoT-protocol capable circuits include low-power wake up transceivers (radios) to receive the wake up signals/initial messages from the IoT ecosystem. IoT protocol capable circuits/vehicles are registered with the IoT controller prior to receiving the messages.

Upon completion of processing the messages, the vehicles may send acknowledgement signals directly to a cloud service using another interface (e.g., cellular or internet-connected Wi-Fi) or via response to the IoT controller using the given IoT protocol.

The IoT-protocol capable circuits in the vehicles may host IoT hubs to allow reception of messages transmitted over different IoT-protocol supported technologies. For instance, a Matter hub module may be capable of transmitting to or receiving messages from other Matter-capable devices over Thread, Wi-Fi, Zigbee, and the like. While a distance between the IoT controller and the vehicle is too long or a heavy path-loss is present due to some reflectors or obstructors, multi-hop links are configured between the IoT controller and the vehicle. The multi-hop links may establish optimal paths between IoT controllers and designated IoT capable nodes in the IoT ecosystem to minimize latency in the messages.

Upon triggering a message sent from the user using a smart device, the smart device may contact the IoT controller to identify whether the vehicle is in the IoT network, and if so, directs the message(s) to the IoT controller instead of sending (e.g., over the internet) the message to first device to shorten the latency.

Embodiments of the disclosure generally provide a system having a first device, an IoT ecosystem, and a vehicle. The first device is operational to transmit a message via a first protocol to the IoT ecosystem. The message may contain one or more commands. The IoT ecosystem has an IoT controller and one or more IoT protocol capable nodes. The IoT controller is operational to receive the message from the first device per the first protocol. One of (i) the IoT controller and (ii) the one or more IoT-protocol capable nodes is operational to transmit wirelessly the message to the vehicle per a given IoT protocol. The given IoT protocol is different than the first protocol.

The vehicle may have an IoT-protocol capable circuit and one or more additional circuits. The IoT-protocol capable circuit is operational to receive the message per the given IoT protocol from the internet-of-things ecosystem, wake up the one or more additional circuits in response to reception of the message, and transfer the message to the one or more additional circuits. The one or more additional circuits are operational to process the message. The one or more additional circuits are non-IoT-protocol capable circuits. The vehicle is operational to transmit an acknowledgement signal external to the vehicle in response to a completion of the processing of the message.

In various embodiments, the electronic circuitry described herein generally comprises at least one microcontroller and/or at least one microprocessor. The at least one microcontroller may include one or more processors, each of which may be embodied as a separate processor, an application specific integrated circuit (ASIC), a field programmable gate array (FPGA), or a dedicated electronic control unit. The at least one microcontroller may be any sort of electronic processor (implemented in hardware, software executing on hardware, or a combination of both). The at least one microcontroller may also include tangible, non-transitory memory, (e.g., read-only memory in the form of optical, magnetic, and/or flash memory). For example, the at least one microcontroller may include application-suitable amounts of random-access memory, read-only memory, flash memory and other types of electrically-erasable programmable read-only memory, as well as accompanying hardware in the form of a high-speed clock or timer, analog-to-digital and digital-to-analog circuitry, and input/output circuitry and devices, as well as appropriate signal conditioning and buffer circuitry. The term “modules” as used herein may be hardware, software executing on hardware, or a combination of both. Various modules may or may not be co-located. In various embodiments, the modules within the vehicle (i.e., the ECUs) may include one or more microprocessors that may use external memory (e.g., random-access memory, read-only memory, flash memory and other types of electrically-erasable programmable read-only memory) and external I/O devices (e.g., analog-to-digital. digital-to-analog, appropriate signal conditioning and buffer circuitry, and the like).

Numerical values of parameters (e.g., of quantities or conditions) in this specification, including the appended claims, are to be understood as being modified in each instance by the term “about” whether or not “about” actually appears before the numerical value. “About” indicates that the stated numerical value allows some slight imprecision (with some approach to exactness in the value; about or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of values and further divided ranges within the entire range. Each value within a range and the endpoints of a range are hereby disclosed as a separate embodiment.

While the best modes for carrying out the disclosure have been described in detail, those familiar with the art to which this disclosure relates will recognize various alternative designs and embodiments for practicing the disclosure within the scope of the appended claims.

What is claimed is:

1. A system comprising:
a first device operational to transmit a message via a first protocol;
an internet-of-things ecosystem with an internet-of-things controller and one or more internet-of-things-protocol capable nodes, wherein:
the internet-of-things controller is operational to receive the message from the first device per the first protocol; and
one of (i) the internet-of-things controller and (ii) the one or more internet-of-things-protocol capable nodes is operational to transmit wirelessly the message per a given internet-of-things protocol; and
the given internet-of-things protocol is different than the first protocol;
a vehicle with an internet-of-things-protocol capable circuit and one or more modules, wherein:
the internet-of-things-protocol capable circuit is operational to:
receive the message per the given internet-of-things protocol from the internet-of-things ecosystem;
wake up the one or more modules in response to reception of the message; and
transfer the message to the one or more modules;
the one or more modules are operational to process the message;
the one or more modules are non-internet-of-thing-protocol capable; and
the vehicle is operational to transmit an acknowledgement signal external to the vehicle in response to a completion of the processing of the message.

2. The system according to claim 1, wherein the internet-of-thing-protocol capable circuit is further operational to:
filter the message among a plurality of allowable messages in the given internet-of-things protocol;
accept the message upon passing the filter; and
reject the message upon failing the filter.

3. The system according to claim 2, wherein:
the internet-of-things-protocol capable circuit includes a vehicle transceiver operational to receive the message per the given internet-of-things protocol from the internet-of-things ecosystem;
the vehicle transceiver is a low-power transceiver while in a standby mode; and
the internet-of-things-protocol capable circuit is operational to wake up the one or more modules in further response to acceptance of the message.

4. The system according to claim 1, wherein:
the internet-of-things ecosystem is further operational to register the vehicle with the internet-of-things controller prior to transmission of the message to the vehicle; and
the vehicle is an internet-of-things device while registered.

5. The system according to claim 1, wherein
the vehicle further includes a vehicle transceiver;
the vehicle transceiver is operational to transmit wirelessly the acknowledgement signal directly to the first device using a second protocol; and
the second protocol is different than the given internet-of-things protocol.

6. The system according to claim 1, wherein the vehicle further includes:
a vehicle transceiver operational to transmit wirelessly the acknowledgement signal to the internet-of-things controller per the given internet-of-things protocol.

7. The system according to claim 1, wherein:
the internet-of-things-protocol capable circuit hosts an internet-of-things hub; and
the internet-of-things hub is operational to communicate via a plurality of internet-of-things supported technologies.

8. The system according to claim 1, wherein:
the internet-of-things ecosystem is further operational to establish a multi-hop path through the one or more internet-of-things nodes between the internet-of-things controller and the vehicle.

9. The system according to claim 1, further comprising:
a smart device operational to transmit the message to the first device, wherein:
the first device is a server computer operational to receive the message from the smart device; and
the server computer is operational to transfer wirelessly the message to the internet-of-things controller via the first protocol.

10. The system according to claim 1, further comprising:
a smart device operational to transmit the message directly to the internet-of-things controller via the given internet-of-things protocol, wherein:
the first device is a server computer; and
the message from the smart device to the internet-of-things controller bypasses the server computer.

11. The system according to claim 1, wherein:
the internet-of-things ecosystem is further operational to cascade the message received from the first device;
the internet-of-things ecosystem includes a designated trusted internet-of-things node of the one or more internet-of-things nodes;
the vehicle includes a vehicle transceiver;
the vehicle transceiver is operational to transmit wirelessly a check-for-command message periodically per a second protocol to the designated trusted internet-of-things node for the message;
the second protocol is different than the given internet-of-things protocol; and
the internet-of-things ecosystem is further operational to transmit wirelessly the message to the vehicle transceiver per the second protocol in response to reception of the check-for-command message.

12. The system according to claim 11, wherein:
the vehicle transceiver is further operational to transmit wirelessly the acknowledgement signal to the designated trusted internet-of-things node per the second protocol.

13. The system according to claim 11, wherein:
the vehicle further includes a battery;
the battery has a state-of-charge; and
a period of the transmission of the check-for-command message from the vehicle transceiver is varied in response to one or more of (i) the state-of-charge of the battery and (ii) a configuration latency.

14. The system according to claim 1, wherein:
the internet-of-things-protocol capable circuit is further operational to register the one or more modules as a pre-condition to transfer the message from the internet-of-things-protocol capable circuit to the one or more modules.

15. The system according to claim 1, wherein:
a designated trusted internet-of-things node of the one or more internet-of-things nodes in the internet-of-things ecosystem is further operational to authenticate the one or more additional circuits in the vehicle as a pre-condition to transmit the message from the designated trusted internet-of-things node to the vehicle.

16. The system according to claim 15, wherein:
the designated trusted internet-of-things node is further operational to filter the message based on the authentication of the one or more modules;
the message is transmitted to the vehicle in response to passing the filter; and
the message is withheld from the vehicle in response to failing the filter.

17. The system according to claim 1, wherein:
the given internet-of-things protocol is a Matter protocol defined by a Matter Specification by Connectivity Standards Alliance.

18. A method for a command and control delivery mechanism comprising:
transmitting a message via a first protocol from a first device;
receiving the message per the first protocol at an internet-of-things controller in an internet-of-things ecosystem from the first device;
transmitting wirelessly the message per a given internet-of-things protocol from one of (i) the internet-of-things controller and (ii) one or more internet-of-things nodes in the internet-of-things ecosystem;
receiving the message per the given internet-of-things protocol at an internet-of-things-protocol capable circuit in a vehicle from the internet-of-things ecosystem;
waking up one or more modules in the vehicle with the internet-of-things-protocol capable circuit in response to the receiving of the message, wherein the one or more modules are non-internet-of-things-protocol capable;
transferring the message from the internet-of-things-protocol capable circuit to the one or more modules additional;
processing the message with the one or more modules; and
transmitting an acknowledgement signal from the vehicle in response to a completion of the processing of the message.

19. The method according to claim 18, further comprising:
cascading the message received from the first device in the internet-of-things ecosystem, wherein:
the internet-of-things ecosystem includes a designated trusted internet-of-things node of the one or more internet-of-things nodes; and
the vehicle includes a vehicle transceiver;
transmitting wirelessly a check-for-command message periodically per a second protocol from the vehicle transceiver to the designated trusted internet-of-things node for the message, wherein the second protocol is different than the given internet-of-things protocol; and
transmitting wirelessly the message from the internet-of-things ecosystem to the vehicle transceiver per the second protocol in response to reception of the check-for-command message at the internet-of-things ecosystem.

20. A vehicle comprising:
a vehicle transceiver operational to receive a message per a given internet-of-things protocol from an internet-of-things ecosystem, wherein
the vehicle is registered with an internet-of-things ecosystem as an internet-of-things device;
one or more modules operational to process the message, wherein the one or more modules are non-internet-of-things-protocol capable circuits;
an internet-of-things-protocol capable circuit operational to:
wake up the one or more modules in response to reception of the message;
transfer the message to the one or more modules; and
host an internet-of-things hub, wherein the internet-of-things hub is operational to communicate via a plurality of internet-of-things supported technologies;
wherein the vehicle transceiver is further operational to transmit an acknowledgement signal external to the vehicle in response to a completion of the processing of the message; and
a wireless transceiver operational to link the vehicle to the Internet, send data to the Internet, and receive data from the Internet.
